(19) United States
(12) Patent Application Publication
(10) Pub. No.: US 2026/0095112 A1
(43) Pub. Date: Apr. 2, 2026

(54) PENDULUM BASED FREQUENCY-UP CONVERTER FOR VIBRATION ENERGY HARVESTING

(71) Applicant: UNIVERSITY OF MARYLAND, BALTIMORE COUNTY, Baltimore, MD (US)

(72) Inventor: Soobum LEE, Woodstock, MD (US)

(21) Appl. No.: 19/073,491

(22) Filed: Mar. 7, 2025

Related U.S. Application Data
(60) Provisional application No. 63/563,578, filed on Mar. 11, 2024.

(51) Int. Cl. H02N 2/18; H01F 7/02

(52) U.S. Cl. CPC H02N 2/186; H01F 7/02

(57) ABSTRACT

A pendulum based frequency up converter that effectively captures a low-speed mechanical rotation into high-frequency vibration of a piezoelectric cantilever beam is disclosed. The pendulum based frequency-up converter for cantilevered piezoelectric energy harvesters can be used to efficiently utilize low rotational motion of wind turbine blades, and other slow rotating structures, to implement a self-powering sensor network to monitor the health of wind turbine blades.

### CROSS REFERENCE TO RELATED APPLICATIONS

This application claims priority to U.S. Provisional Patent Application No. 63/563,578 filed on Mar. 11, 2024 in the name of Soobum LEE and entitled “Pendulum Based Frequency-Up Converter for Vibration Energy Harvesting,” which is hereby incorporated by reference herein in its entirety.

### GOVERNMENT SUPPORT CLAUSE

This invention was made with government support under Grant Number 2131373, awarded by the National Science Foundation. The government has certain rights in the invention.

### FIELD

The present invention relates to a pendulum based frequency-up converter that swings within a circular section confined by a pair of magnets on the outer section. A PEH cantilever beam is mounted to the pendulum, and voltage is induced as the pendulum swings and the cantilever beam vibrates.

### BACKGROUND

For the past decade, energy harvesting techniques have gathered more attention, mainly due to the rapid advance in technology of low-power wireless sensor networks. Such networks have the potential to be utilized for many practical monitoring tasks while consuming very low amounts of power consumption [Knight, 2008; Yan, 2020]. Batteries are the power sources for most of the sensor nodes, but they have unsolved issues such as power leakage, chemical leakage, and labor cost for battery replacement. These problems can be solved by using energy harvesting technology, which has been advanced to accommodate easy implementation, high efficiency, low cost, and high durability to be a more practical power solution to the sensor networks [Yan, 2020].

There are several techniques for harvesting environmental energy: solar, heat, wind, radio frequency, and vibrations. A piezoelectric energy harvester (PEH) has been previously studied as a method to convert vibrational energy into electrical energy. PEHs benefit from a simple structure, case of implementation, and high-power output compared to various harvesting techniques [Liu, 2018; Xing, 2009; Erturk and Inman, 2011; Kim, 2011]. A variety of applications of PEHs harvesting energy are known including from animals/human bodies, machinery, vehicles, bridges, road, water flow, and wind [Yang, 2018; Zhang, 2017; Yang, 2014; Xu, 2018; Liu, 2021; Choudhry, 2020]. While the piezoelectric harvester can be used anywhere with vibrations, the hardest task that most researchers face is to improve its power generation level by matching the ambient frequency to the natural frequency of the PEH.

In most cases, a piezoelectric harvester system can only perforM efficiently at its resonant frequency [Ong, 2019]. One group found that the piezoelectric beam generates reliable power output when it is excited at a frequency between 80-110 Hz [Zhang, 2017]. Disadvantageously, this makes it hard to harvest a low speed vibration from a large rotary structure like a wind turbine blade that has a rotational frequency of less than 1 Hz or 60 RPM, and the piezoelectric actuator will not be able to generate a practical amount of power if installed directly on these large rotary structures. Numerous studies about manipulating the frequency of either excitation structures or piezoelectric actuators have been conducted. For example, another group proposed a two degree-of-freedom (DOF) nonlinear piezoelectric energy harvester that significantly broadens operating bandwidth, which consists of two cantilever beams, which create two resonance frequencies, and two magnets, which add nonlinearity characteristics to the design to remove anti-resonance frequency [Wu, 2014]. A similar design with a dual-cantilever structure and magnet-induced piezoelectric harvester was carried out by Su et al. [Su, 2014]. Still another group introduced an L-shaped beam consisting of three piezoelectric beams and two masses to achieve broader bandwidth than a simple cantilever beam [Erturk, 2008]. Hu. et al. have studied a spiral-shaped bimorph piezoelectric harvester, and it was found that spiral-shaped structure operates at a lower frequency compared to beam structure [Hu, 2006]. The broadband harvester concepts could improve the harvester performance even when the frequency input is varied, but they still have limited performance in utilizing low-frequency vibrations.

There are several studies designing harvester devices with frequency up-conversion techniques that convert low frequency from the rotary structure to higher frequency, to match the frequency of the piezoelectric actuator. Fu and Yeatman studied a piezoelectric harvester using a bi-stability design, which utilized two sets of magnets to excite the piezoelectric beam; it could vibrate the piezoelectric beam at resonance frequency with a driving frequency of 5 Hz [Fu, 2019]. Another group proposed a design of a tri-stable piezoelectric harvester using two external magnets and significantly enhanced the power performance compared to a bi-stable design [Wang, 2019]. Pozzi and Zhu designed a rotational harvester which used the plectrum effect to achieve frequency-up conversion, however, the design created significant vibrational interference in the structure [Pozzi, 2012]. A music-box-like plucking energy harvester has been proposed to solve the issue [Fang, 2019], and a shape optimization study for the plucking harvester has been performed [Park, 2012].

There continues to be a need in the art for an improved frequency-up converter, for example, to devise a self-powering monitoring sensor node for wind turbine blades or any slow rotary systems. Wind energy is the third-largest power source in the U.S, and the number of wind turbines has increased dramatically in the recent decade. Accordingly, a self-powering sensor network to monitor the health of wind turbine blades is important. A self-powering sensor that harvests ambient energy could help to reduce operational and manufacturing costs compared to conventional sensors with wires, which not only simplifies the wire installation process but also reduces the cost of battery replacement.

### SUMMARY

In some aspects, a pendulum based frequency-up converter device is described, said device comprising:
a pendulum having a length r_{P}, wherein the pendulum has a first end and a second end, wherein the first end is a fixed pivot point and the pendulum swings, relative to the fixed pivot point, in a circular sector of angle 2θ_{mag}, and the pendulum further comprises a fourth magnet fixed at the second end at r_{P}; and
three fixed magnets, wherein a first magnet and a second magnet are fixed at a first outer bound and a second outer bound of the circular sector, respectively, and a third magnet is positioned at angle θ_{mag} from either outer bound at a magnet distance r_{M} from the fixed pivot point, wherein r_{M} is greater than r_{P}.

In other aspects, a piezoelectric energy harvester (PEH) is described, said PEH comprising:
a pendulum having a length r_{P}, wherein the pendulum has a first end and a second end, wherein the first end is a fixed pivot point and the pendulum swings, relative to the fixed pivot point, in a circular sector of angle 2θ_{mag}, and the pendulum further comprises a fourth magnet fixed at the second end at r_{P};
three fixed magnets, wherein a first magnet and a second magnet are fixed at a first outer bound and a second outer bound of the circular sector, respectively, and a third magnet is positioned at angle θ_{mag} from either outer bound at a magnet distance r_{M} from the fixed pivot point, wherein r_{M} is greater than r_{P}; and
a piezoelectric cantilever beam mounted on the pendulum, wherein the piezoelectric cantilever beam comprises a tip mass (mₐ).

In still another aspect, rotary structure comprising two or more blades and at least one piezoelectric energy harvester (PEH) is described, wherein a PEH as described herein is positioned on or within at least one blade.

In yet another aspect, a method of generating sustainable electrical energy is described, said method comprising harvesting the energy from a rotary structure and converting it to electrical energy, said method comprising positioning a PEH as described herein on or within a blade of the rotary structure, and connecting the PEH to a power management circuit and a storage unit, wherein the vibrational/kinematic energy of the rotary structure is converted to sustainable battery-free electrical energy.

Other aspects, features and embodiments of the invention will be more fully apparent from the ensuing disclosure and appended claims.

### BRIEF DESCRIPTION OF THE FIGURES

FIG. 1. An embodiment of the piezoelectric harvester as described herein, as positioned inside of a wind turbine blade.

FIG. 2A. A schematic model of the piezoelectric harvester as described herein with respect to Global Coordinate (X, Y).

FIG. 2B. A schematic model of the piezoelectric harvester as described herein with respect to Local Coordinate (x₁, y₁).

FIG. 3. A modified version of frequency up converter with a rotating disk based on the previous studies done by Nezami and Lee.

FIG. 4A. A schematic of a first model of the modified version of frequency up converter with a rotating disk with respect to Global Coordinate (X, Y).

FIG. 4B. A schematic of a first model of the modified version of frequency up converter with a rotating disk with respect to Local Coordinate (x₁, y₁).

FIG. 5A. A schematic of a second model of the modified version of frequency up converter with a rotating disk with respect to Global Coordinate (X, Y).

FIG. 5B. A schematic of a second model of the modified version of frequency up converter with a rotating disk with respect to Local Coordinate (x₁, y₁).

FIG. 6A. Pendulum displacement at 10 RPM (initial condition of θ₀=−15°).

FIG. 6B. Voltage output at 10 RPM (initial condition of θ₀=−15°).

FIG. 7. Pendulum harvester simulation result before and after optimization.

FIG. 8A. Disk displacement at 10 RPM before optimization.

FIG. 8B. Harvester displacement at 10 RPM before optimization.

FIG. 8C. Voltage output at 10 RPM before optimization.

FIG. 9. Power output density for disk concept (next to harvester) before and after optimization.

FIG. 10A. Disk displacement at 10 RPM before optimization.

FIG. 10B. Harvester displacement at 10 RPM before optimization.

FIG. 10C. Voltage output at 10 RPM before optimization.

FIG. 11. Power output density for disk concept (above harvester) before and after optimization.

FIG. 12A. Pendulum based harvester response.

FIG. 12B. Disk driven harvester responses.

FIG. 13A. Pendulum harvester CAD model.

FIG. 13B. Pendulum harvester 3D-printed model.

FIG. 14. Experimental setup connection.

FIG. 15. Power output versus magnet distance.

FIG. 16. Simulated result versus experimental result.

FIG. 17A. Simulated voltage output at 15 RPM.

FIG. 17B. Experimental voltage output at 15 RPM.

### DETAILED DESCRIPTION, AND PREFERRED EMBODIMENTS THEREOF

Although the claimed subject matter will be described in terms of certain embodiments, other embodiments, including embodiments that do not provide all of the benefits and features set forth herein, are within the scope of this disclosure as well. Various structural and parameter changes may be made without departing from the scope of this disclosure.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents, and other references mentioned herein are incorporated by reference in their entirety. The materials, methods, and examples disclosed herein are illustrative only and not intended to be limiting.

“About” and “approximately” are used to provide flexibility to a numerical range endpoint by providing that a given value may be “slightly above” or “slightly below” the endpoint without affecting the desired result, for example, +/−5%.

The phrase “in one embodiment” or “in some embodiments” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As defined herein, a “rotary structure” includes any structure comprising rotating blades such as a wind turbine. In addition, a rotary structure can be any object that spins about a central axis, for example, amusement park rides, cranks, and wheels.

It is well known to the person skilled in the art that a “sector” of a circle, or a “circular sector,” is defined by an arc and the two radii of the circle. This is also referred to as a “swinging fan area.” Further, for the purpose of this disclosure, the two radii correspond to the “outer bounds” of the circular sector.

Motivated to run a self-powering monitoring sensor on a rotary structure such as a wind turbine blade, a pendulum based frequency-up converter that effectively captures a low-speed mechanical rotation and converts same into a high-frequency vibration of a piezoelectric cantilever beam is described. The pendulum based frequency up converter design described herein utilizes gravitational and magnetic forces and when coupled with the piezoelectric cantilever beam, practical power output suited for rotary objects in low frequency, such as wind turbine blades having a rotational speed less than 1 Hz, can be generated.

In a first aspect, a pendulum based frequency-up converter device is described, said device comprising:
a pendulum having a length r_{P}, wherein the pendulum has a first end and a second end, wherein the first end is a fixed pivot point and the pendulum swings, relative to the fixed pivot point, in a circular sector of angle 2θ_{mag}, and the pendulum further comprises a fourth magnet fixed at the second end at r_{P}; and
three fixed magnets, wherein a first magnet and a second magnet are fixed at a first outer bound and a second outer bound of the circular sector, respectively, and a third magnet is positioned at angle θ_{mag} from either outer bound at a magnet distance r_{M} from the fixed pivot point, wherein r_{M} is greater than r_{P}.

In a second aspect, a piezoelectric harvester (PEH) is described, said PEH comprising the pendulum based frequency-up converter device of the first aspect and a piezoelectric cantilever beam mounted on the pendulum, wherein the piezoelectric cantilever beam comprises a tip mass (mₐ).

In some embodiments of the second aspect, the PEH comprises:
a pendulum having a length r_{P}, wherein the pendulum has a first end and a second end, wherein the first end is a fixed pivot point and the pendulum swings, relative to the fixed pivot point, in a circular sector of angle 2θ_{mag}, and the pendulum further comprises a fourth magnet fixed at the second end at r_{P}; and
three fixed magnets, wherein a first magnet and a second magnet are fixed at a first outer bound and a second outer bound of the circular sector, respectively, and a third magnet is positioned at angle θ_{mag} from either outer bound at a magnet distance r_{M} from the fixed pivot point, wherein r_{M} is greater than r_{P}; and
a piezoelectric cantilever beam mounted on the pendulum, wherein the piezoelectric cantilever beam comprises a tip mass (mₐ).

In some embodiments, the PEH is positioned on or within at least one blade of a rotary structure, such as a wind turbine.

A schematic model of the pendulum based frequency-up converter device comprising the piezoelectric cantilever beam, with respect to Local Coordinates (x₁, y₁), is shown in FIG. 2B. In some embodiments, the pendulum has a length r_{P}, wherein a first end of the pendulum is a fixed pivot point of the circular sector and the pendulum swings relative to the fixed pivot point between a first outer bound and a second outer bound. In some embodiments, the circular sector of angle 2θ_{mag}, or the swinging fan area defined by the two outer bounds, can have an angle 2θ_{mag}, wherein the angle θ_{mag} is in a range from about 10° to about 30°, or from about 25° to about 30°. The pendulum based frequency-up converter device further comprises three fixed magnets, wherein the first magnet and second magnet are positioned at substantially the same length r_{P} from the fixed pivot point, e.g., as shown in FIG. 2B, and the first magnet is positioned at, or defines, a first outer bound and the second magnet is positioned at, or defines, a second outer bound. In some embodiments, a third magnet is positioned at angle θ_{mag} from either outer bound (or put another way, in the middle between each outer bound) at a magnet distance r_{M} from the fixed pivot point, wherein r_{M} is greater than r_{P}, as illustrated in FIG. 2B. The pendulum also comprises a fourth magnet fixed at the second end, and hence at a distance of r_{P} relative to the fixed pivot point. It should be appreciated by the person skilled in the art that the first, second, third, and fourth magnets can be the same as or different from one another in terms of mass, size, magnetic strength, etc. In some embodiments, the first, second, third, and fourth magnets are the same as one another. In some other embodiments, at least one of the first, second, third, and fourth magnets is different from the others, as readily understood by the person skilled in the art.

FIG. 2B further illustrates an embodiment of the positioning of the flexible piezoelectric cantilever beam, wherein the piezoelectric beam is mounted on the pendulum and has a tip mass mₐ positioned at a distance of r_{H}, relative to the fixed pivot point. As illustrated in FIG. 2B, r_{P} is greater than r_{H}. In some embodiments, the attraction of the third and fourth magnets hold the pendulum in position until gravitational forces enable a sudden downward motion of the pendulum, simultaneously triggering vibrations in the piezoelectric cantilever beam and generating electrical energy.

In practice, the PEH comprising the piezoelectric cantilever beam, which is flexible and is mounted on the pendulum, can be used to harvest a low speed vibration from a large rotary structure.

The detailed design specification such as piezoelectric cantilever beam shape and circuit components can be readily determined by the person skilled in the art using design optimization techniques. For example, a cantilever beam can comprise lead zirconate titanate (PZT) materials laminated as a patch on both sides of a shim, for example a shim comprising blue steel. To reduce the material deterioration, the piezoelectric cantilever can be entirely encased within an external shell or case that protects the piezoelectric harvester from the outdoor environment. This layered structure will protect the piezoelectric material and improve the structural durability.

In some embodiments, the absolute power value, or RMS of the PEH is optimized by manipulating the pendulum length (r_{P}), the tip mass (mₐ) and the positioning of same relative to the pivot point (i.e., r_{H}), the θ_{mag}, and the distance between the fourth magnet and the third magnet (r_{M}−r_{P}=dₘ). In some embodiments, the maximum harvester tip displacement is minimized for device durability. The person skilled in the art can readily determine the appropriate values for maximizing the power output of the PEH device depending on the rotary structure to be monitored.

In some embodiments, the frame of the pendulum based frequency-up converter device, or the PEH device, can be easily envisioned by the person skilled in the art. For example, as illustrated in FIG. 13A, a CAD drawing can be generated and the device printed using 3D printing techniques (see, FIG. 13B). As shown in FIGS. 13A-13B, which represents an experimental pendulum based frequency-up converter device for optimizing power output, a pendulum based frequency-up converter device can comprise an outer frame, a center frame and a pendulum for positioning of the piezoelectric cantilever beam. The outer frame comprises two single rung ladders arranged as an A-frame wherein one end of each ladder is at the fixed pivot point, and each ladder comprises a single rung for positioning of the first and second magnets, as described herein, wherein the rung is positioned at r_{P}. The outer frame defines the first and second outer bounds of the circular sector. The center frame, also having one end at the fixed pivot point, has a rung for positioning of the third magnet. As described herein, and illustrated in FIG. 13A, the rung for the third magnet is positioned at a greater distance (i.e., at r_{M}) from the fixed pivot point than the respective rungs for the first and second magnets. Further illustrated in FIG. 13A is the pendulum, which also has a first end at the fixed pivot point and a second end, or pendulum rung, for positioning of the fourth magnet at r_{H}. It should be appreciated that the pendulum provides for the positioning of the fourth magnet at the rung, but also must allow the piezoelectric cantilever beam, once mounted on the pendulum, to be displaced when the pendulum swings due to gravitational forces. As shown in FIG. 13A, an embodiment of the pendulum comprises an open area defined by the pendulum rung, two pendulum arms that connect the pendulum rung to the fixed pivot point, and the location where the piezoelectric cantilever beam is mounted to the pendulum. The displacement of the piezoelectric cantilever beam results in vibrations which can be harvested as electrical energy. It should be appreciated by the skilled artisan that the frame of the pendulum based frequency-up converter device, or the PEH, can further comprise a base and other supporting braces to ensure the longevity of the PEH frame over time. Further, to reduce material deterioration, the PEH device can be entirely encased within an external shell or case that protects the piezoelectric harvester from the outdoor environment. This layered structure will protect the piezoelectric material and improve the structural durability.

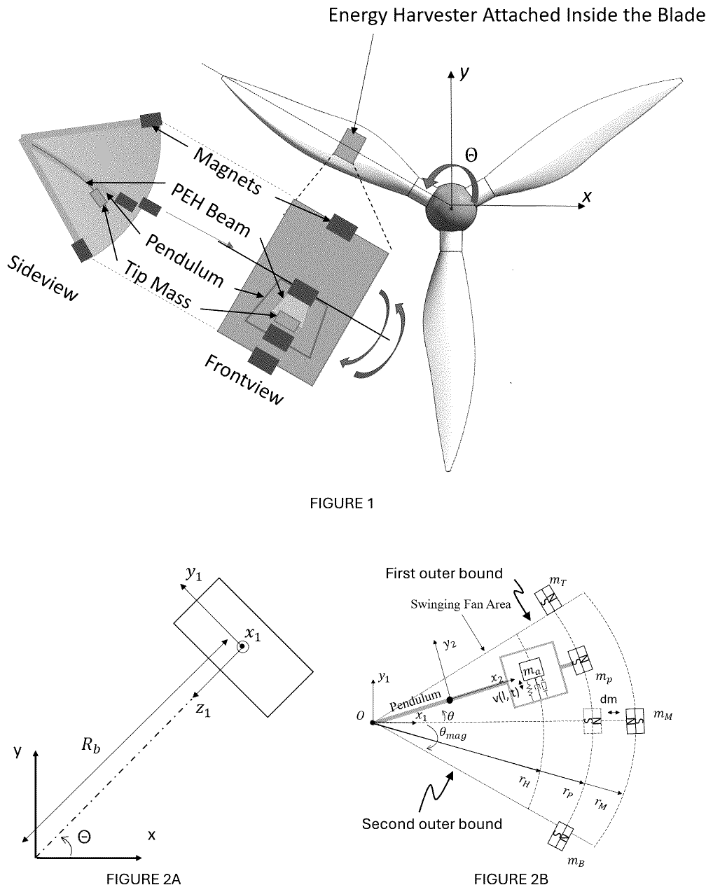

In a third aspect, a rotary structure is described, wherein the rotary structure comprises two or more blades and at least one blade comprises at least one PEH of the second aspect on or within said blade, for example as shown in FIG. 1. The energy harvester can be connected to a power management circuit and storage unit (e.g., a supercapacitor), which can thereby supply sustainable electrical energy to a device that requires electrical energy, as readily understood by the person skilled in the art.

In a fourth aspect, a method of generating sustainable electrical energy, said method comprising harvesting the energy from a rotary structure and converting it to electrical energy, said method comprising positioning the PEH of the second aspect in or on a blade of a rotary structure, and connecting the PEH to a power management circuit and a storage unit, wherein the vibrational/kinematic energy of the rotary structure is converted to sustainable battery-free electrical energy. In one embodiment, the rotary structure is a wind turbine comprising two or more blades and the sustainable battery-free electrical energy is needed to operate a structural sensor.

The features and advantages of the invention are more fully illustrated by the following non-limiting examples, wherein all parts and percentages are by weight, unless otherwise expressly stated.

### Example 1

### I. Conceptual Designs and Mathematical Model Derivation of Harvester Dynamics

a. Pendulum Based Frequency-Up Converter

FIG. 1 illustrates an embodiment of the pendulum based frequency-up converter for cantilevered piezoelectric energy harvesters that will efficiently utilize low rotational motion of wind turbine blades, as described herein, positioned within a blade of a wind turbine, while FIGS. 2A-2B show the schematic model. Broadly, the harvester comprises a pendulum swinging in a circular sector. The swinging of the pendulum is controlled by three fixed magnets, one in the middle (m_{M}) and the other two (m_{T} and m_{B}) on the outer bounds of the circular sector. The fourth magnet is attached on the tip of moving pendulum (m_{P}). The middle magnet (m_{M}) holds the pendulum until it has enough downward force by gravity. Holding the pendulum is important because it enables a sudden downward motion when the gravitational force increases. The piezoelectric beam is mounted on the pendulum, so that voltage is induced when the pendulum swings.

The equation of motion is derived to demonstrate the energy harvesting performance as follows. There are 3 coordinates: a global coordinate system (X, Y, Z) at the center of the rotation of the blade, 2 local coordinate systems, (x₁, y₁, z₁) at the pivot point of the pendulum, and (x₂, y₂, z₂) at the root of the cantilevered PEH beam. Θ describes the blade orientation with respect to global coordinates (X, Y, Z), θ is the angular position of the pendulum with respect to the local coordinates (x₁, y₁, z₁), and v is the local position of the tip mass of the harvester.

The following assumptions are made to simplify the modeling process of the harvesters, as follows: the cantilevered beam is assumed to be an Euler Bernoulli beam with a uniform cross-section, linear stiffness, and small deflection; the damping ratios of the pendulum swing and the beam deflection are assumed to be constant; magnetic repelling force is assumed to be a function of the distance between two magnets and the effect of magnet rotation is neglected; and only the first mode shape function is considered for the beam vibration.

Table 1 shows the design variables used during the mathematical modeling process.

TABLE 1
Variables used in the mathematical model

| Symbol | Description |
|---|---|
| R_{b} | Center of the harvester to origin |
| | of the global coordinate |
| rₚ | Length of the pendulum |
| r_{H} | Distance from the local coordinate |
| | origin to the harvester tip mass |
| r_{M} | Distance from the local coordinate |
| | origin to the intermediate magnet |
| l | Length of the PZT harvester |
| Θ | Angular position of the harvester |
| | in global coordinate |
| θ | Angular position of the pendulum |
| | in local coordinate |
| θ_{mag} | Angular displacement of the outer |
| | magnet to the center of the |
| | pendulum swinging area |

The location of the pendulum tip in the global coordinate is:

$$\{ \begin{matrix}{x}_{p} = {R}_{b} cos Θ - {r}_{P} sin θsinΘ \\ {y}_{p} = {R}_{b} sin Θ + {r}_{P} sin θ cos Θ \\ {z}_{p} = {r}_{p} cos θ\end{matrix} \qquad ( 1 )$$

The location of the PEH beam tip mass:

$$\{ \begin{matrix}{x}_{t} = {R}_{b} cos Θ - {r}_{H} sin θsinΘ - v ( l , t ) cos θ sin Θ \\ {y}_{t} = {R}_{b} sin Θ + {r}_{H} sin θcos Θ + v ( l , t ) cos θcos Θ \\ {z}_{tf} = {r}_{H} cos θ - v ( l , t ) sin θ\end{matrix} \qquad ( 2 )$$

where v(l) describes the vibration of the PEH with respect to the local coordinate system (x₂, y₂, z₂), and/indicates the PEH beam length. The reduced vibration mode of the cantilever beam, v(x₂) in the discretized modal coordinate can be formulated as:

$$v ( {x}_{2} , t ) = ϕ ( {x}_{2} ) q ( t ) \qquad ( 3 )$$

where q(t) is the normal coordinate and φ(x₂) is the first mode shape function of the cantilevered beam as:

$${ϕ}_{n} ( {x}_{2} ) = cosh ( β {x}_{2} ) - cos ( β {x}_{2} ) - σ ( sinh β {x}_{2} - sin {βx}_{2} ) \qquad ( 4 )$$

$$\{ \begin{matrix}β \times l = 1.87510407 \\ σ = 0. 7341\end{matrix}$$

Similar to equation (2.2), the location of any part of the cantilevered beam is written as:

$$\{ \begin{matrix}{x}_{s} = {R}_{b} cos Θ - ( {r}_{H} - l + {x}_{2} ) sin θsinΘ - v ( x 2 , t ) cos θ sin Θ \\ {y}_{s} = {R}_{b} sin Θ + ( {r}_{H} - l + {x}_{2} ) sin θcos Θ + v ( x 2 , t ) cos θcos Θ \\ {z}_{s} = ( {r}_{H} - l + {x}_{2} ) cos θ - v ( x 2 , t ) sin θ\end{matrix} \qquad ( 5 )$$

In this example, the energy method and Lagrange's equation are used to derive the equation of motions of the system. Using the energy method significantly simplifies the derivation of the governing differential equations of motion [Palazzolo, 2016]. This method provides a tool to consider the distributed mass of the flexible PEH beam and magnetic potential energy in the analytical model.

The kinetic energy of the design concept can be written as:

$$T = \frac{1}{2} ( {I}_{p} + {I}_{b} ) * {\dot{θ}}^{2} + \frac{1}{2} {m}_{a} ( {\dot{x}}_{t}^{2} + {\dot{y}}_{t}^{2} + {\dot{z}}_{t}^{2} ) + \frac{1}{2} {m}_{s} {\int }_{0}^{l} ( {\dot{x}}_{s}^{2} + {\dot{y}}_{s}^{2} + {\dot{z}}_{s}^{2} ) {dx}_{2} \qquad ( 6 )$$

$$where$$

$${I}_{P} = {m}_{P} {r}_{p}^{2} , {I}_{b} = \frac{1}{2} {m}_{c} {r}_{p}^{2} ,$$

indicated as moment of inertia of pendulum tip, pendulum, respectively; m_{P} is the mass of magnets (all magnets are identical in the design); mₐ, m_{c}, mₛ are mass attached to the PEH, mass of the pendulum, and mass per length (kg/m) of the PEH beam, respectively.

The total potential energy of the energy harvester can be expressed as:

$${U}_{total} = {U}_{p} + {U}_{t} + {U}_{s} + {U}_{e} + {U}_{mp} + {U}_{v} \qquad ( 7 )$$

where Uₚ, Uₜ, and Uₛ are the gravitational energy of the pendulum, pendulum tip, harvester tip mass, and harvester, respectively. Uₑ is the elastic potential energy of the PEH, Ump is the magnetic potential energy between magnets, and Uᵥ is the electrical potential energy of the PEH.

The magnetic potential energy can be calculated from the work-energy theorem (Equation (8)). The magnetic force between the two magnets is extracted from experimental data not shown herein. Using a two-term exponential function to interpolate, the force data can be represented as Equation (2.9).

$${U}_{mp} = - {\int }_{{r}_{1}}^{{r}_{2}} F ( r ) \partial r \qquad ( 8 )$$

$$F ( x ) = {ae}^{bx} + {ce}^{dx} \qquad ( 9 )$$

Substituting Equation (9) in Equation (8), the magnetic potential can be written as:

$${U}_{mp} = - \frac{a}{b} {e}^{b \times {l}_{T}} - \frac{c}{d} {e}^{d \times {l}_{T}} - \frac{a}{b} {e}^{b \times {l}_{B}} - \frac{c}{d} {e}^{d \times {l}_{B}} - \frac{a}{b} {e}^{b \times {l}_{M}} - \frac{c}{d} {e}^{d \times {l}_{M}} \qquad ( 10 )$$

where I_{T}, I_{B}, and I_{M} are magnetic distances between m_{P} and three other magnets, written as:

$${l}_{T} = 2 {r}_{P} sin ( \frac{1}{2} ( {θ}_{mag} - θ ( t ) ) ) \qquad ( 11 )$$

$${l}_{B} = 2 {r}_{P} sin ( \frac{1}{2} ( {θ}_{mag} + θ ( t ) ) ) \qquad ( 12 )$$

$${l}_{M} = \sqrt{( {( {r}_{p} cos θ ( t ) - {r}_{M} )}^{2} + {( {r}_{p} sin θ ( t ) )}^{2} )} \qquad ( 13 )$$

The strain energy of the PZT layers is defined as:

$${u}_{vp} = - \frac{1}{2} {\int }_{0}^{lp} {υ}_{p} {V}_{1} ( t ) \frac{{\partial }^{2} {v}_{1} ( {x}_{2} )}{\partial {x}_{2}^{2}} {dx}_{2} + \frac{1}{2} {C}_{p} {V}_{1}^{2} ( t ) - \frac{1}{2} {\int }_{0}^{lp} {υ}_{p} {V}_{2} ( t ) \frac{{\partial }^{2} {v}_{2} ( {x}_{3} )}{\partial {x}_{3}^{2}} {dx}_{3} + \frac{1}{2} {C}_{p} {V}_{2}^{2} ( t ) \qquad ( 14 )$$

where V(t) is the voltage across the electrodes on the PEH domain, vₚ is the electromechanical coupling term [Erturk, 2018], and Cp is the capacitance of PZT defined as:

$${υ}_{p} = \frac{{e}_{31} {b}_{p}}{{h}_{p}} [ {( {h}_{p} + \frac{{h}_{s}}{2} )}^{2} - \frac{{h}_{s}^{2}}{4} ] \times H ( {l}_{p} - x ) \qquad ( 15 )$$

$${C}_{p} = {ε}_{33} \frac{{b}_{p} {l}_{p}}{{h}_{p}} \qquad ( 16 )$$

$$where {e}_{33} = {d}_{31} {E}_{p} and {ε}_{33} = {d}_{31} / {g}_{31} .$$

The potential energy of the energy harvester can be formulated as:

$$U = {m}_{P} {gy}_{p} + {m}_{a} {gy}_{t} + {gm}_{s} {\int }_{0}^{l} {y}_{s} {dx}_{2} + \frac{1}{2} {\int }_{0}^{l} {Elv}^{″2} {dx}_{2} - \frac{1}{2} {\int }_{0}^{l} {v}_{p} V ( t ) {v}^{″2} {dx}_{2} + \frac{1}{2} {C}_{P} {V}^{2} ( t ) - \frac{a}{b} {e}^{{bl}_{M}} - \frac{c}{d} {e}^{{dl}_{M}} - \frac{a}{b} {e}^{{bl}_{T}} - \frac{c}{d} {e}^{{dl}_{T}} - \frac{a}{b} {e}^{{bl}_{B}} - \frac{c}{d} {e}^{{dl}_{B}} \qquad ( 17 )$$

Using the electromechanical Lagrange's equation based on the extended Hamilton's principle [Yang, 2018], a system of three equations of motion for the EH is derived as:

$$\frac{d}{dt} ( \frac{\partial T}{\partial {\dot{q}}_{ι}} ) - \frac{\partial T}{\partial {q}_{i}} + \frac{\partial U}{\partial {q}_{i}} = \frac{δ W}{δ {q}_{i}} \qquad ( 18 )$$

$$\frac{d}{dt} ( \frac{\partial T}{\partial \dot{θ}} ) - \frac{\partial T}{\partial θ} + \frac{\partial U}{\partial θ} = \frac{δ W}{δ θ} \qquad ( 19 )$$

Substituting equations (6), and (17) into equations (18), and (19), and taking corresponding derivatives will result in the following equations:

$${c}_{1} \dot{q} ( t ) + ( {m}_{a} {r}_{H}^{2} + {m}_{S} {r}_{s}^{2} - {r}_{P}^{2} ( 0.5 {m}_{c} + {m}_{P} ) ) \ddot{θ} ( t ) + ( {m}_{a} ϕ ( l ) {r}_{H} + {m}_{s} {\int }_{0}^{l} ϕ ( {y}_{1} ) {dy}_{1} {r}_{s} + q ( t ) ) \ddot{q} ( t ) + ( {m}_{a} ϕ ( l ) + {m}_{s} {\int }_{0}^{l} ϕ ( {y}_{1} ) {dy}_{1} ) g cos ( θ ( t ) ) cos ( Θ ) + α q ( t ) - χ V ( t ) - q ( t ) ( {\dot{θ}}^{2} ( t ) + {cos}^{2} ( θ ( t ) ) {\dot{Θ}}^{2} ) - 0.5 * ( {m}_{a} ϕ ( l ) {r}_{H} + {m}_{s} {r}_{s} {\int }_{0}^{l} ϕ ( {y}_{1} ) {dy}_{1} ) sin ( 2 θ ( t ) ) {Θ}^{2} = 0 \qquad ( 20 )$$

$$( 21 )$$

$${c}_{2} \dot{θ} ( t ) + ( {m}_{a} ϕ ( l ) {r}_{H} + {m}_{s} {\int }_{0}^{l} ϕ ( {y}_{1} ) {dy}_{1} {r}_{s} ) \ddot{θ} ( t ) + \ddot{q} ( t ) + ( {lm}_{s} {r}_{H} - 0.5 {l}^{2} {m}_{s} + {m}_{a} {r}_{H} + {m}_{P} {r}_{P} ) g cos ( θ ( t ) ) cos Θ - ( 0.5 {m}_{a} {r}_{H}^{2} + 0.5 {m}_{s} {r}_{s}^{2} ) sin ( 2 θ ( t ) ) {Θ}^{2} + q ( t ) ( 2 \dot{q} ( t ) \dot{θ} ( t ) + 0.5 q ( t ) sin ( 2 θ ( t ) ) {\dot{Θ}}^{2} ) - ( {m}_{a} ϕ ( l ) + {m}_{s} {\int }_{0}^{l} ϕ ( {y}_{1} ) {dy}_{1} ) gq ( t ) cos Θ sin ( θ ( t ) ) - ( {m}_{a} ϕ ( l ) {r}_{H} + {m}_{s} {r}_{s} {\int }_{0}^{l} ϕ ( {y}_{1} ) {dy}_{1} ) q ( t ) cos ( 2 θ ( t ) ) {Θ}^{2} - \frac{\begin{matrix}a * exp ( b \sqrt{{r}_{M}^{2} + {r}_{P}^{2} - 2 {r}_{M} {r}_{P} cos ( θ ( t ) )} ) + \\ c * exp ( d \sqrt{{r}_{M}^{2} + {r}_{P}^{2} - 2 {r}_{M} {r}_{P} cos ( θ ( t ) )} )\end{matrix}}{\begin{matrix}\sqrt{{r}_{M}^{2} + {r}_{P}^{2} - 2 {r}_{M} {r}_{P} cos ( θ ( t ) )}\end{matrix}} + {r}_{P} cos ( \frac{1}{2} ( {θ}_{mag} - θ ( t ) ) ) ( {ae}^{2 b * {r}_{P} sin ( \frac{1}{2} ( {θ}_{mag} - θ ( t ) ) )} + {ce}^{2 d * {r}_{P} sin ( \frac{1}{2} ( {θ}_{mag} - θ ( t ) ) )} ) - {r}_{P} cos ( \frac{1}{2} ( {θ}_{mag} + θ ( t ) ) ) ( {ae}^{2 b * {r}_{P} sin ( \frac{1}{2} ( {θ}_{mag} + θ ( t ) ) )} + {ce}^{2 d * {r}_{P} sin ( \frac{1}{2} ( {θ}_{mag} + θ ( t ) ) )} ) = 0$$

where φ(x)=Cφₙ(x) and φₙ is the normalized shape function presented in Equation (4). To meet the orthogonality of the eigenfunctions, C is calculated to satisfy the following equation:

$${\int }_{0}^{l} {m}_{sp} {ϕ}^{2} ( {x}_{2} ) {dx}_{2} + {m}_{t} {ϕ}^{2} ( l ) = 1 \qquad ( 22 )$$

The governing electrical equation based on Kirchhoff's law can be described as below:

$${C}_{p} \frac{{dv}_{p} ( t )}{dt} + \frac{{v}_{p} ( t )}{2 {R}_{l}} - {i}_{p} = 0 \qquad ( 23 )$$

$$where {i}_{p} = - κ \frac{dq ( t )}{dt} ,$$

and κ is the modeling coupling term

$${κ = {e}_{31} {h}_{pc} b \frac{d ϕ ( x )}{dx} \vert}_{x = l} ,$$

and h_{pc} describes the distance from the piezoelectric material to the neutral axis. Equations (20), (21), and (23) are the completed ODE equation set. Table 2 shows the design variables used during the mathematical modeling process.

TABLE 2
Modeling parameters for the harvester.

| Symbol | Description | Value | |
|---|---|---|---|
| hₚ | Thickness of PZT layer | 0.00015 | [m] |
| hₚₛ | Thickness of substrate | 0.00014 | [m] |
| | between two PZT layers | | |
| hₛ | Thickness of PPA-2011 | 0.00076 | [m] |
| lₘₐ | Length of magnet | 0.0191 | [m] |
| lₚ | Length of PZT layer | 0.0402 | [m] |
| lₛ | Effective length of PPA-2011 | 0.0465 | [m] |
| mₘ | Weight of magnet | 0.0115 | [kg] |
| mₛ | Mass per length of PPA-2011 | 0.062738 | [kg] |
| R_{b} | Distance of harvester | 0.6 | [m] |
| | center from O | | |
| wₘ | Width of magnet | 0.0064 | [m] |

b. Disk Driven Frequency-Up Converter

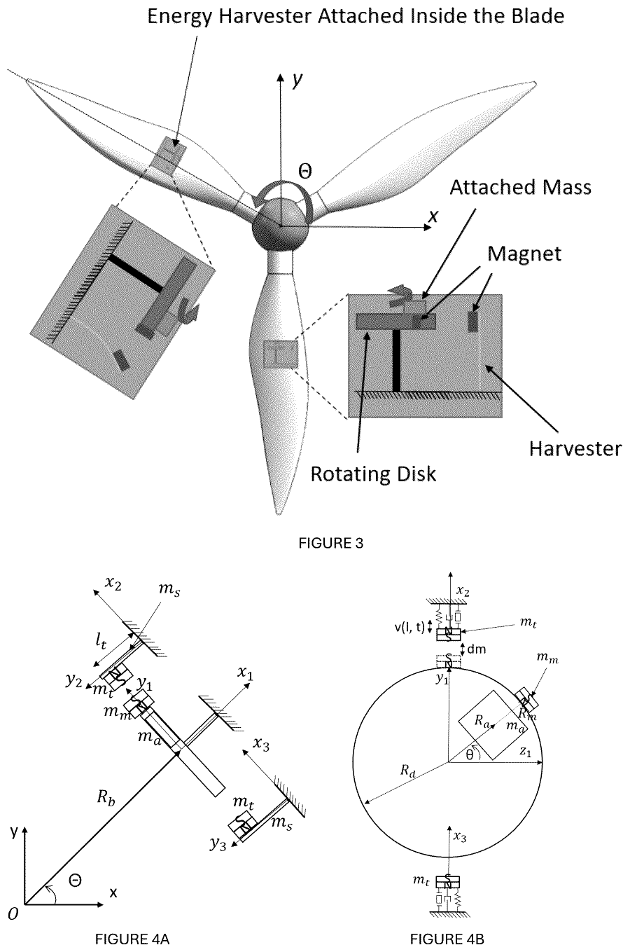

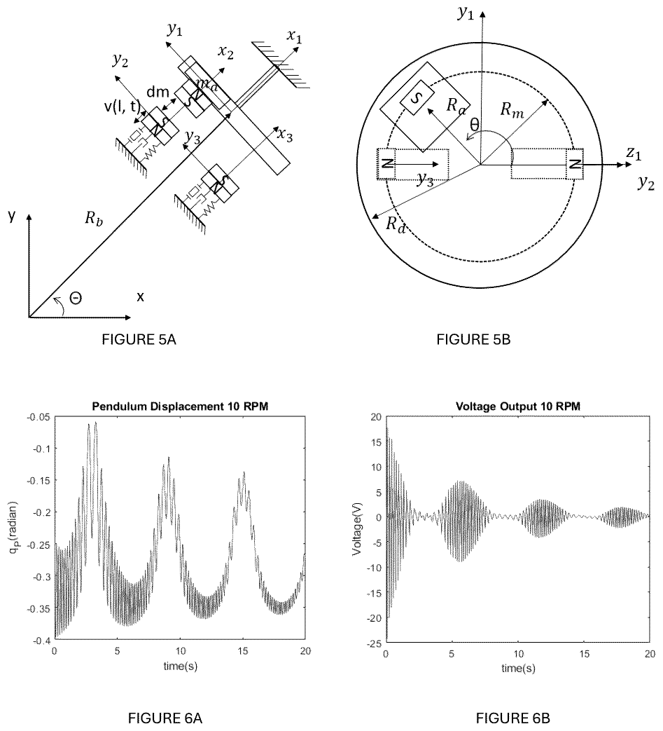

A modified version of frequency up converter with a rotating disk is introduced to compare the performance with the pendulum based one introduced hereinabove. This modified version frequency up converter with a rotating disk is based on the previous studies done by Nezami and Lee [Nezami, 2020]. Similar to the pendulum based converter, the disk orientation is toward the ground due to gravity while the cantilevered harvester follows the blade orientation, however the disk rotation is not limited to a circular sector, as shown in FIG. 3. Two kinds of disk driven harvesters were devised by placing cantilevered piezoelectric harvesters at different positions: (1) laterally next to the disk (FIGS. 4A-4B); and (2) below the circular disk area (FIGS. 5A-5B). In both figures, the cantilevered harvester is represented as a cantilevered beam or a spring-mass-damper system depending on the viewpoint.

The first layout is identical to the previous work of Nezami and Lee with two cantilevered harvesters, and the second layout is motivated to use smaller device volume by relocating the harvesters within the disk area. To describe the dynamics of the energy harvester (EH), four coordinate systems are used: a global coordinate system (X, Y, Z) at the center of rotation of the blade, three local coordinate systems (x₁, y₁, z₁) at the center of rotation of the disk, (x₂, y₂, z₂) at the fixed end of the first cantilevered PEH beam and (x₃, y₃, z₃) at the fixed end of the second cantilevered PEH beam. The three local coordinate systems are fixed on the blade. Θ describes the blade orientation with respect to global coordinates (x, y, z), is the angular position of the attached mass and magnet (mₐ and mₘ) with respect to the local coordinates (x₁, y₁, z₁), and v₁ and v₂ is the directional position of the mₜ and mₛ in local coordinates (x₂, y₂, z₂) and (x₃, y₃, z₃) respectively. The detailed derivation of dynamic equations are done using Lagrange's method (not presented herein) similar to the work by Nezami and Lee [Nezami, 2020]. This concept can be implemented with a larger number of harvesters, but experience dictated that the disk rotation is trapped by an increased number of magnets and the power is not generated efficiently.

### II. Simulation Study and Design Optimization

The theoretical power output of the three types of harvester devices was found by solving the equations of motion derived based on the energy method. The equation was solved in MATLAB numerically using the built-in function ODE45. The equation solver simulates the harvester dynamics using a typical rotational speed of a large-scale wind turbine blade from 7 to 20 RPM. Initial values for harvesters such as \dot{θ}, \ddot{θ}, \dot{q}, \ddot{q}, V, \dot{V} are assumed to be zeros. The numerical results are simulated with a sufficient time span (50˜60 sec) with the fixed time steps (0.01 s). The power output is measured through a resistor that is connected to the harvester in parallel at every time step, and the root mean square (RMS) of these power outputs is calculated for comparison between different concepts. Then the design of each concept is optimized to maximize the power RMS.

a. Pendulum Based Harvester

Simulation and design optimization for the frequency up converter using the pendulum was performed. The parameters of magnet distance, tip mass, and length of pendulum before optimization are dₘ=20 mm, mₐ=70 g, and r_{P}=15 cm, respectively. The harvester dynamics equations were solved numerically using the MATLAB ODE45 solver to simulate three dynamic responses (pendulum angular position, harvester tip displacement, and the voltage) as shown in FIGS. 6A-6B when the blade rotational speed (Θ)=10 RPM and the pendulum initial position was θ=−15°. The figures show that the pendulum only swings on one side (negative angular position) of the circular sector, causing low voltage output from the PEH beam. This limited swing motion is due to the strong magnetic force between the pendulum and the intermediate magnets (mₚ and mₘ), and insufficient kinetic energy of the dropping pendulum to pass by the intermediate magnet. An increased magnetic distance or increased mass weight will solve this issue, and this investigation motivates a systematic design optimization.

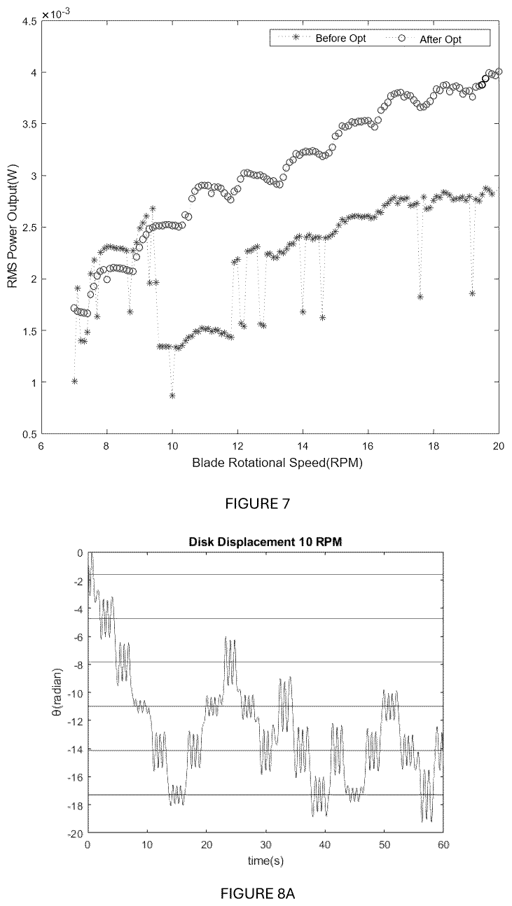

The RMS power measure during 10 blade rotations was used for performance evaluation. To account for varied harvester dynamics dependent on initial conditions and blade rotational speed, the six different initial conditions on the pendulum's angular position were simulated (θ=27°, 15°, 3°, −3°, −15°, −27°) at varied blade speed (Θ=7 and 20 at 1 RPM increment), and their average RMS power was calculated and plotted as shown in FIG. 7 (red star marks-before optimization). This setup produced a power output of 2.20 mW. The maximum tip displacement was 14.7 mₘ, which is within the constraint of 15.5 mₘ by the manufacturer (PPA-2011, Mide Corp.). The power profile curve in FIG. 7 shows an increasing trend as the RPM of the blade increases, but there are significant power drops found in some RPM conditions including 10 RPM.

The optimization process for the pendulum harvester considers the maximization of power density using the three parameters of r_{P}, mₐ and dₘ, or:

$$max \frac{Power ( {r}_{P} , {m}_{a} , {d}_{m} )}{{r}_{P}} \qquad ( 24 )$$

$$s . t . Max Tip ( {r}_{P} , {m}_{a} , {d}_{m} ) < 15.5 mm$$

$$Power ( {r}_{P} , {m}_{a} , {d}_{m} ) > 1 mW$$

The objective function accounts for the power per device volume, but the formulation was simplified as the power per device radius while the device angle (60°) and depth (80 mm) were fixed. Two constraints indicate to: (1) limit the maximum tip displacement for device durability; and (2) meet the minimum required power by a sensor node. The optimization study will consider the averaged RMS power at six different pendulum initial conditions (θ).

The optimization was performed using fmincon in MATLAB, with a nonlinear gradient based algorithm (SQP). The optimized result shows an overall increase in power output (blue circle marks—after optimization, FIG. 7) compared to the result before optimization. An overall increasing trend was demonstrated, while the power drop points were removed due to the increased inertia effect (increased mass). The power output density was increased from 0.0147 W/m to 0.0338 W/m and the absolute power value was increased from 2.20 mW to 3.07 mW. The optimized parameters are shown in Table 3 and the power improvement was enabled by reduced magnet distance (from 20 mm to 17.1 mm), an increase in attached mass weight (from 70 g to 114.5 g), and reduced pendulum length (from 15 cm to 9.06 cm).

TABLE 3
Optimized result - harvester on the pendulum.

| | | | |
|---|---|---|---|
| Design | Pendulum length (rₚ) | 15.0→9.06 | cm |
| parameters | Harvester tip mass (mₐ) | 70.0→114.5 | g |
| | Magnet distance (dₘ) | 20.0→17.1 | mm |
| Harvester | Maximum tip displacement | 12.13 | mm |
| performances | RMS power | 3.07 | mW |

b. Disk Driven Harvester

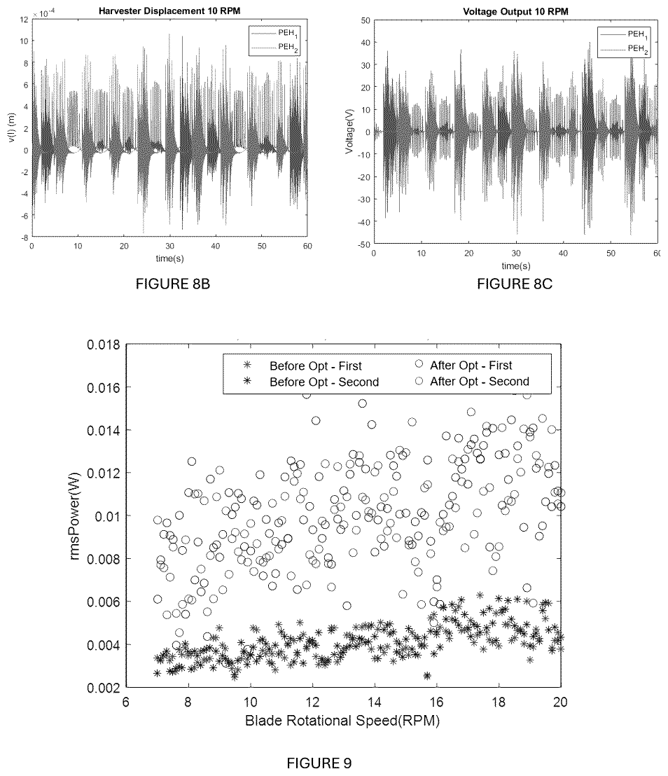

For performance comparison purpose, this section performs design optimization for a frequency up converter with a disk as introduced in section I(b) hereinabove. Analogous to the previous section, the harvester dynamics equations are solved numerically using the MATLAB ODE45 solver to simulate five dynamic responses (disk rotation, two harvester tip displacements, and two voltages). FIGS. 8A-8C show one case study when Θ=10 RPM. The initial model uses the following parameters: r_{P}=8 cm, dₘ=12 mm. FIG. 8A demonstrates the disk response, where the blue and red horizontal lines represent the positions of the first and second PEH, respectively. Whenever the disk passes through either PEH, the corresponding harvester displacement and voltage output are stimulated as shown in FIGS. 8B and 8C. The blue and red colors indicate the response of harvester 1 and 2, respectively.

FIG. 9 shows the power output of the harvester from each harvester before (star marks) and after (circle marks) optimization. Before optimization, this configuration produces 4.75 mW power and 8.37 mm maximum tip displacement. While the maximum tip displacement is well below the constraint of maximum displacement of 15.5 mm, it has the potential to increase power output by design optimization.

A design formulation to maximize power output density is suggested as follows:

$$max \frac{Power ( {R}_{d} , {d}_{m} )}{{R}_{d}} \qquad ( 25 )$$

$$s . t . Max Tip ( {R}_{d} , {d}_{m} ) < 15.5 mm$$

$${Power}_{rms} > 2 mW$$

A doubled power requirement is assigned compared to the pendulum based concept, because there exist two harvesters in this concept. The optimized result is summarized shown in Table 4. The maximum tip displacement was 12.61 mm, less than the maximum allowed value, and the power output was 20.15 mW (power sum from the two harvesters).

TABLE 4
Optimized result - harvester next to the disk.

| | | | |
|---|---|---|---|
| Design | Disk Radius (R_{d}) | 13.02 | cm |
| parameters | Magnet Distance (dₘ) | 8.5 | mm |
| Harvester | Maximum tip displacement | 12.61 | mm |
| performances | RMS power | 20.15 | mW |

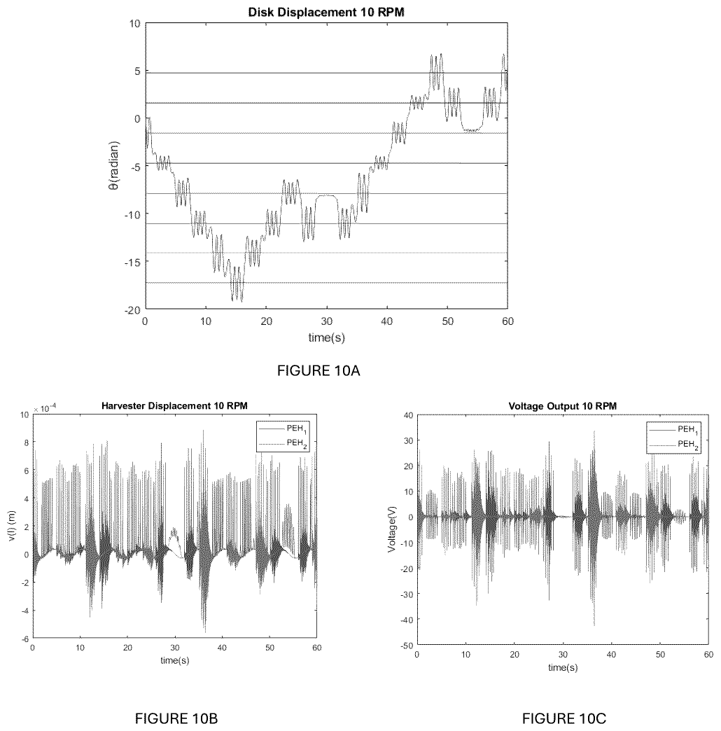

A similar optimization process was performed for the disk driven concept that places the two harvesters below the disk. FIGS. 10A-10C show the dynamic response before optimization, which has the same initial parameter as the previous disk driven harvester. By comparing these two sets of figures, FIGS. 8A-8C and 10A-10C, it was found that the dynamic response is less active in terms of the amplitude of disk rotation, harvester displacement, and the voltage. As the magnet and harvester sets have moved closer to the center of the disk, under the same disk rotational speed, the passing speed will be reduced, and the PEH will be stimulated by a smaller force. As a result, it is expected that this concept (harvester below the disk) produces lower power output compared to the previous concept (harvester next to the disk).

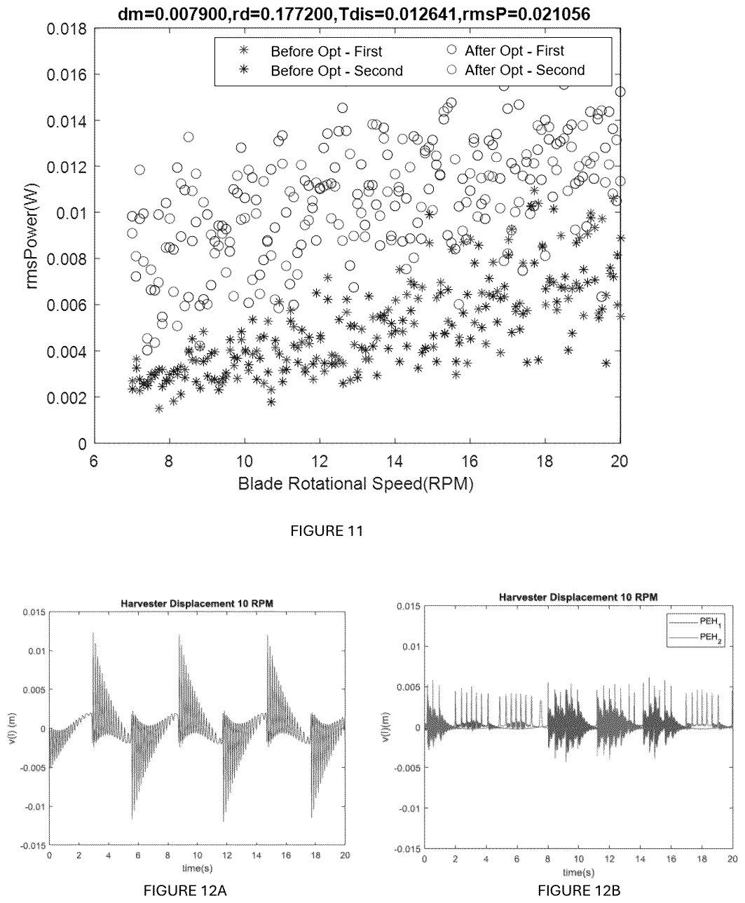

The power output before the optimization was 1.01 mW with a maximum tip displacement of 6.42 mm which is well below the constraint of 15.5 mm. The same optimization process in Equation (25) was performed to maximize power density by changing the parameters of disk radius Ra and magnet distance dₘ. In the optimized model, the maximum tip displacement was 12.64 mm and the RMS power measure was 21.06 mW (Table 5; FIG. 11).

TABLE 5
Optimized result - harvester below the disk.

| | | | |
|---|---|---|---|
| Design | Disk Radius | 17.72 | cm |
| parameters | Magnet Distance | 7.9 | mm |
| Harvester | Maximum tip displacement | 12.64 | mm |
| performances | RMS power | 21.06 | mW |

c. Simulated Result Comparison

The performance analysis of the two frequency up converters mainly focuses on the power output density of each design simulated from 7 to 20 RPM. The power densities were calculated by dividing power by length dimension (e.g., pendulum length or disk radius). As the pendulum concept only swings a section of a circle (60°), for fairness, the power density of the pendulum obtained from Table 3 will be multiplied by 6 to compare with the two disk concepts that considers the power from two harvesters. The power densities of the three concepts are summarized in Table 6 below.

TABLE 6
Power Density Comparison.

| | Pendulum | Disk Next | Disk |
|---|---|---|---|
| | PEH | to PEHs | above PEHs |
| Power | 0.203 | 0.155 | 0.119 |
| Density(W/m) | | | |

The concept with the pendulum shows the highest power output density, while the disk concept (disk above harvester) produces the lowest power output density. As discussed in Section II(b), the harvesters were moved below the disk to improve the power density, but this relocation resulted in slower stimulation on the PEHs and lower power generation. Overall, the pendulum based concept demonstrates efficient power generation in a limited device volume.

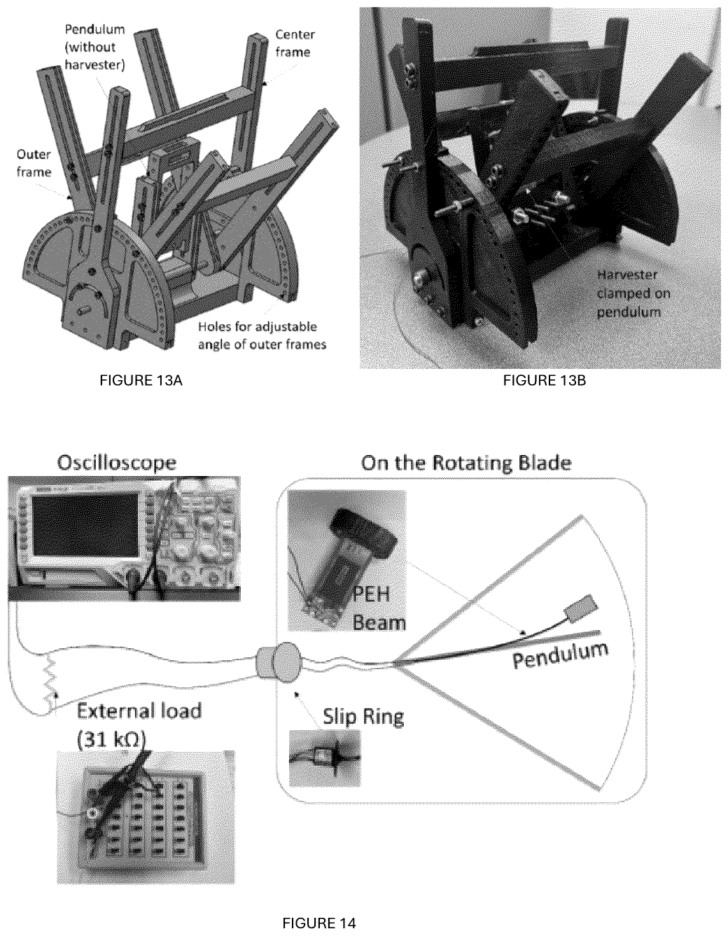

Moreover, in the disk driven concepts, the rotation dynamics is not perfectly periodic with uncertainty that causes uneven stimulation of the harvester. However, in the pendulum based concept described herein, each cycle of harvester vibration was identical as shown in FIG. 12A. The stable and regularized dynamic response was beneficial for electrical power charging to increase the charging efficiency [Jung, 2019]. To conclude, the pendulum based concept described herein outperforms the disk driven concept in terms of the power density and signal regularization.

### III. Experimental Verification

a. Experimental Setup

Most parts of the prototype of the pendulum harvester were created using 3D printing techniques and a Solidworks computer-aided design (CAD) model shown in FIG. 13A. This concept was designed to have various test results with changeable parameters: discrete multiple holes for adjusting the pendulum's swinging area, and the bars with the slots for continuously changeable magnetic distance. The CAD model was fabricated using the 3D printer (Gmax 1.5XT) with PLA material (FIG. 13B).

The experimental setup was built. A wooden blade was attached to a fixture rotated by an electromotor (Marathon electric K258) to simulate the rotation of a wind turbine blade. The angular velocity of the electromotor was controlled by a variable frequency driver (Automation Direct GS2). A digital magnetic tachometer sensor was used to measure the rotational velocity of the blade. The 3D printed harvester device was attached on the wooden blade, 0.6 m away from the center of the wooden blade. Four identical magnets (BX048, K&J Magnetics) are used in the prototype. The pendulum was attached to the center axis (aluminum rod) with two bearings. The PZT-5J piezoelectric beam (PPA-2011, Mide Corp.) was clamped to the pendulum with screws. The tip mass was implemented by wrapping 120 g of heavy-duty lead tape.

The connection of devices is shown in FIG. 14. The wires from the piezoelectric beam were attached along the blade pass through a slip ring to a variable resistor (Tenma 72-7270). The resistance value (51.5 kΩ) was found from a sweep test on resistance, to produce the maximum power output by attaching the piezoelectric beam to the vibrator ET-126-1 (Labworks Inc.) vibrating at resonance frequency. The oscilloscope (Rigol DS1054) was used to read voltage output from the harvester.

b. Data Collection and Verification

A sensitivity analysis by the change of the design variables was conducted in Table 7. The power generation performance was most sensitive by magnetic distance (dₘ) followed by pendulum radius and the mass use, because the optimized magnet distance sits at the border of passing and bouncing behaviors. The power was also decreased by the reduced radius (r_{P}) and mass (mₐ) because of the insufficient inertia to enable passing behavior, buts its change is moderate than the case by dₘ. Their increased values do not change the power significantly, but it possibly causes the violation of the displacement constraint.

TABLE 7
Sensitivity analysis on power.

| | 90% of | 100% | 110% of |
|---|---|---|---|
| Design variable | optimal | (optimal) | optimal |
| Magnet distance (dₘ) | 0.334 mW | 3.07 mW | 2.79 mW |
| | (15.4 mm) | (17.1 mm) | (18.9 mm) |
| Radius (rₚ) | 2.65 mW | 3.07 mW | 3.07 mW |
| | (8.15 cm) | (9.06 cm) | (9.96 cm)* |
| Mass (mₐ) | 1.48 mW | 3.07 mW | 3.07 mW |
| | (103.05 g) | (114.5 g) | (126.0 g) |

*Tip displacement condition was violated by 2.41% (15.87 mm).

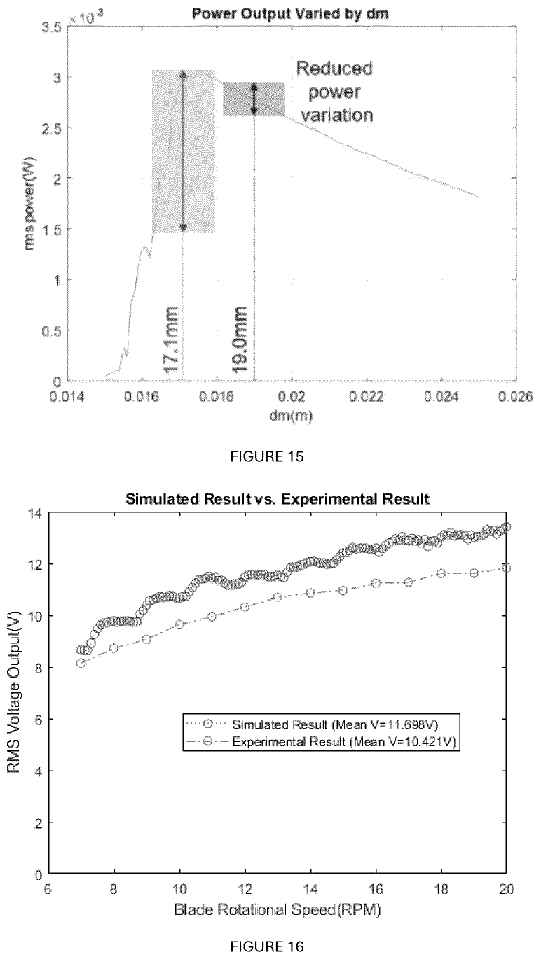

The change of the power by the magnetic distance (dₘ) is displayed in FIG. 15. When the optimal dₘ was used in the experiment, its small decrease will result in drastic power decrease because the increased magnetic force, and the pendulum does not pass the intermediate magnet anymore and bounces back to swing within the half of the circular sector (as in FIG. 6). Additionally, 3D printed structures have higher dimension uncertainty compared to other manufacturing techniques, which may result in uncertain dₘ parameter. For design robustness, the magnetic distance needs to be adjusted so that power becomes less sensitive. The new dₘ was set as 19 mₘ. When dₘ was assumed to vary ±5 mₘ, the power variation was reduced by 85% (1.65−0.25 mW) by sacrificing the power from 3.07 to 2.78 mW (about 10% reduction).

To collect precise and accurate data, the experiment was run with 10 trials. Each trial collects 20 seconds of voltage output from 7 to 20 RPM of the wooden blade rotation. The sampling rate was set as 250 per second to collect the voltage history.

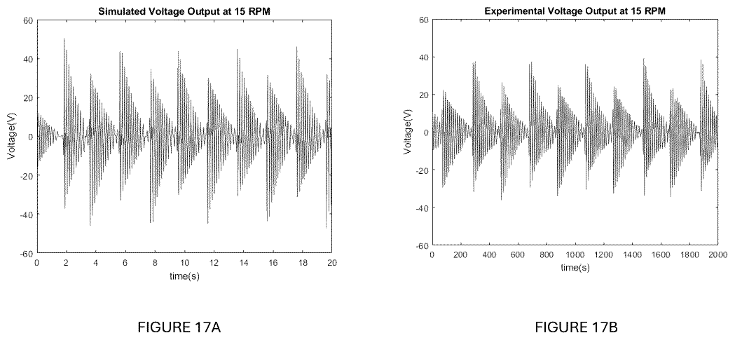

The experimental result and simulated response with extended magnetic distance are shown in FIG. 16. The experimental result was found lower in mean terms of the RMS power (FIG. 16) and the voltage output (FIG. 17) compared to the simulated result. There are several possible factors to result in power reduction in addition to the increased dₘ. Firstly, there might be inconsistent product data compared to the actual performance of the PEH beam. Secondly, the clamped boundary condition is not ideally presented due to flexibility and dimension variability of a 3D printed structure with PLA material. However, the experimental result is only 10.9% lower in mean voltage output compared to the simulated result, and the overall waveforms show good agreement.

### IV. Conclusion

This example introduces three concepts of a piezoelectric energy harvester that are capable of collecting energy from wind turbine blade rotations. The frequency-up conversion technique is used in the three concepts to transform low rotation frequency from a wind turbine blade to the higher vibrational frequency of the PEH cantilevered beam. The mathematical models of three concepts were developed, and the dynamic responses of each harvester simulated. Each concept was optimized with various parameters including mass, magnetic distance, size and PEH location(s), and their optimized results of each concept were compared. The pendulum based concept utilizes a pendulum that swings within a circular section confined by a pair of magnets on the outer section. A PEH beam is mounted to the pendulum, and the voltage is induced as the pendulum swings. Another magnet is intermediately placed to improve the pendulum dynamics and generate more power. The disk driven concepts, on the other hand, utilize the swinging motion of a disk to stimulate vibration on a piezoelectric beam by magnetic repelling force. Compared to the disk driven concept, the pendulum based concept produces a higher power density. The optimized result of the pendulum based concept was prototyped and tested on a rotating structure to verify the performance experimentally.

Although the invention has been variously disclosed herein with reference to illustrative embodiments and features, it will be appreciated that the embodiments and features described hereinabove are not intended to limit the invention, and that other variations, modifications and other embodiments will suggest themselves to those of ordinary skill in the art, based on the disclosure herein. The invention therefore is to be broadly construed, as encompassing all such variations, modifications and alternative embodiments within the spirit and scope of the claims hereafter set forth.

### REFERENCES

Choudhry, I., Khalid, H. R. & Lee, H.-K., 2020. Flexible piezoelectric transducers for energy harvesting and sensing from human kinematics. ACS Applied Electronic Materials, 2 (10), pp. 3346-3357.
Erturk, A. & Inman, D. J., 2011. Piezoelectric Energy Harvesting, Chichester: John Wiley & Sons.
Erturk, A., Renno, J. M. & Inman, D. J., 2008. Modeling of piezoelectric energy harvesting from an L-shaped beam-mass structure with an application to uavs. Journal of Intelligent Material Systems and Structures, 20 (5), pp. 529-544.
Fang, S. et al., 2019. A music-box-like extended rotational plucking energy harvester with multiple piezoelectric cantilevers. Applied Physics Letters, 114 (23), p. 233902.
Fu, H., Yeatman, E. M., 2019. Rotational energy harvesting using bi-stability and frequency up-conversion for low-power sensing applications: Theoretical modelling and experimental validation. Mech. Sys. and Signal Processing, 125, pp. 229-244.
Hu, Y., Hu, H. & Yang, J., 2006. A low frequency piezoelectric power harvester using a spiral-shaped bimorPh. Science in China Series G: Physics, Mechanics and Astronomy, 49 (6), pp. 649-659.
Jung, H. J., Nezami, S. and Lee, S., 2019. Power supply switch circuit for intermittent energy harvesting. Electronics, 8 (12), p. 1446.
Kim, H. S., Kim, J.-H. & Kim, J., 2011. A review of piezoelectric energy harvesting based on vibration. International Journal of Precision Engineering and Manufacturing, 12 (6), pp. 1129-1141.
Knight, C., Davidson, J. & Behrens, S., 2008. Energy Options for wireless sensor nodes. Sensors, 8 (12), pp. 8037-8066.
Liu, X., 2012. An electromagnetic energy harvester for powering consumer electronics. TigerPrints. Available at: https://tigerPrints.clemson.edu/all_theses/1415 [Accessed Sep. 22, 2022].
Liu, Y. et al., 2021. Piezoelectric energy harvesting for self-powered wearable upper limb applications. Nano Select, 2 (8), pp. 1459-1479.
Nezami, S. & Lee, S., 2020. Nonlinear Dynamics of a rotary energy harvester with a double frequency up-conversion mechanism. Journal of Computational and Nonlinear Dynamics, 15(9).
Ong, Z. C., Huang, Y.-H. & Chou, S.-L., 2019. Resonant frequency reduction of piezoelectric voltage energy harvester by elastic boundary condition. Journal of Mechanics, 35 (6), pp. 779-793.
Palazzolo, A. B., 2016. Vibration theory and applications with finite elements, Chichester, West Sussex, United Kingdom: John Wiley & Sons, Inc.
Park, J., Lee, S. and Kwak, B. M., 2012. Design optimization of piezoelectric energy harvester subject to tip excitation. Journal of Mechanical Science and Technology, 26 (1), pp. 137-143.
Pozzi, M. & Zhu, M., 2012. Characterization of a rotary piezoelectric energy harvester based on plucking excitation for knee-joint wearable applications. Smart Materials and Structures, 21 (5), pp 55004.
Wang, G. et al., 2019. Nonlinear magnetic force and dynamic characteristics of a tri-stable Piezoelectric Energy Harvester. Nonlinear Dynamics, 97 (4), pp. 2371-2397.
Xing, X. et al., 2009. Wideband vibration energy harvester with high permeability magnetic material. Applied Physics Letters, 95 (13), p. 134103.
Xu, X. et al., 2018. Application of piezoelectric transducer in energy harvesting in Pavement. International Journal of Pavement Research and Technology, 11 (4), pp. 388-395.
Yan, B. et al., 2020. Scavenging vibrational energy with a novel Bistable Electromagnetic Energy Harvester. Smart Materials and Structures, 29 (2), p. 025022.
Yang, Y. et al., 2014. Rotational piezoelectric wind energy harvesting using impact-induced resonance. Applied Physics Letters, 105 (5), p. 053901.
Yang, Z. et al., 2018. High-performance piezoelectric energy harvesters and their applications. Joule, 2 (4), pp. 642-697.
Zhang, J. et al., 2017. A rotational piezoelectric energy harvester for efficient wind energy harvesting. Sensors and Actuators A: Physical, 262, pp. 123-129.

What is claimed is:

1. A pendulum based frequency-up converter device comprising:
a pendulum having a length r_{P}, wherein the pendulum has a first end and a second end, wherein the first end is a fixed pivot point and the pendulum swings, relative to the fixed pivot point, in a circular sector of angle 2θ_{mag}, and the pendulum further comprises a fourth magnet fixed at the second end at r_{P}; and
three fixed magnets, wherein a first magnet and a second magnet are fixed at a first outer bound and a second outer bound of the circular sector, respectively, and a third magnet is positioned at angle θ_{mag} from either outer bound at a magnet distance r_{M} from the fixed pivot point, wherein r_{M} is greater than r_{P}.

2. The pendulum based frequency-up converter device of claim 1, wherein the angle θ_{mag} is in a range from about 10° to about 30°.

3. The pendulum based frequency-up converter device of claim 1, wherein the angle θ_{mag} is in a range from about 25° to about 30°.

4. The pendulum based frequency-up converter device of claim 1, wherein the swinging of the pendulum is controlled by the first, second, and third magnets.

5. The pendulum based frequency-up converter device of claim 1, wherein the first magnet and second magnet are positioned at substantially the same length r_{P} from the fixed pivot point.

6. The pendulum based frequency-up converter device of claim 1, wherein the first, second, third, and fourth magnets are the same as or different from one another.

7. The pendulum based frequency-up converter device of claim 1, further comprising a piezoelectric cantilever beam mounted on the pendulum, wherein the piezoelectric cantilever beam comprises a tip mass (mₐ).

8. The pendulum based frequency-up converter device of claim 7, wherein the tip mass is positioned at a distance r_{H} from the fixed pivot point, wherein r_{P} is greater than r_{H}.

9. The pendulum based frequency-up converter device of claim 7, wherein the piezoelectric cantilever beam is flexible.

10. A piezoelectric energy harvester (PEH) comprising the pendulum based frequency-up converter device of claim 7.

11. The PEH of claim 10, wherein the attraction of the third and fourth magnets hold the pendulum until gravitational forces enable a downward motion of the pendulum, simultaneously triggering vibrations in the piezoelectric cantilever beam and generating electrical energy.

12. A rotary structure comprising two or more blades and at least one piezoelectric energy harvester (PEH) of claim 10, wherein the PEH is positioned on or within at least one blade.

13. The rotary structure of claim 12, wherein the rotary structure is a wind turbine.

14. The rotary structure of claim 12, wherein the piezoelectric energy harvester is connected to a power management circuit and storage unit.

15. A method of generating sustainable electrical energy, said method comprising harvesting the energy from a rotary structure and converting it to electrical energy, said method comprising positioning the PEH of claim 10 on or within a blade of the rotary structure, and connecting the PEH to a power management circuit and a storage unit, wherein the vibrational/kinematic energy of the rotary structure is converted to sustainable battery-free electrical energy.
